(19) United States
(12) Patent Application Publication
(10) Pub. No.: US 2005/0023012 A1
(43) Pub. Date: Feb. 3, 2005

(54) Three point hitch

(76) Inventor: Stewart Bowden, Gregory, MI (US)

Correspondence Address: Barbara M Burns, 1756 Plymouth Road #276, Ann Arbor, MI, 48105, US

(21) Appl. No.: 10/416,562

(22) PCT Filed: Sep. 16, 2002
(86) PCT No.: PCT/US02/29432

Related U.S. Application Data
(60) Provisional application No. 60/322,883, filed on Sep. 17, 2001.
(60) Provisional application No. 60/407,547, filed on Aug. 30, 2002.

(51) Int. Cl. A01B 59/043

(52) U.S. Cl. 172/439

(57) ABSTRACT

A three point hitch for attachment of an implement to the rear of a construction vehicle. The three point hitch uses brackets fixed to the vehicle with a frame mounted thereto. An intermediate part is movably attached to the frame. A hydraulic cylinder operates between the frame and the intermediate part to lift and lower an implement attached to the intermediate part. Attachment of the implement to the rear of the vehicle allows the operator to drive forward and to drag the implement behind. The frame call be detached from the attachment points on one side of the vehicle and can bc swiveled aside to allow access to the construction vehicle.

### REFERENCE TO RELATED APPLICATION

This application is based on U.S. provisional patent application Ser. No. 60/322,883, filed Sep. 17, 2001 and U.S. provisional patent application Ser. No. 60/407,547, filed Aug. 30, 2002.

### BACKGROUND OF THE INVENTION

The field of the invention pertains to implements for construction vehicles and, in particular, to a hitch for attachment of implements to construction vehicles.

A major problem with construction vehicles is that attachment of many implements must be made to the front of the vehicle. This makes it difficult to use the implement and potentially dangerous because the driver must operate the vehicle in reverse and twist around to look behind to see where the vehicle is headed. This can be awkward at best and certainly unsafe.

A way to attach implements to a uniloader or other construction vehicle was needed to allow the operator to move the vehicle in a forward direction to use the implement. With a view toward providing a more useful and safe attachment for an implement to a vehicle, applicant has developed the following improved hitch.

### SUMMARY OF THE INVENTION

The movable hitch device for attaching an implement to the rear of a construction vehicle comprises brackets or means for holding affixed to the rear of a vehicle, a frame connected to the brackets, a movable intermediate part connected to the frame, and a hydraulic cylinder connected with the hydraulic system of the vehicle and controllable by the vehicle operator to raise and lower the movable intermediate part to which an implement has been attached. The implement can be moved between the position for use and repositioned from the position for use.

The benefit realized by attachment of the implement to the rear of the vehicle allows the operator to drive forward and to drag the implement behind. This increases efficiency as well as safety. Moreover, the implement can be stored attached to the vehicle if desired until the next time for use. The implement can also be easily removed if desired. Other forward action operations can be carried out with the vehicle while the implement remains attached to the rear of the vehicle either in the use (lowered) position or in the raised position.

The three point hitch attachment can be mounted to be released from one side or the other allowing the hitch and a device mounted to the hitch to be swung/swiveled to one side thereby allowing access to the uniloader. Thus can the radiator or other engine components be easily accessed for maintenance tasks.

### BRIEF DESCRIPTION OF THE DRAWINGS

FIG. 1 illustrates a perspective view of the three point hitch with rake attached;

FIG. 2 illustrates a perspective view of the three point hitch with hydraulic cylinder;

FIG. 3 illustrates a view of the back of a front end loader showing the hitch attachment points;

FIG. 4 illustrates a perspective view of the back of a front end loader showing the hitch attachment points;

FIG. 4A illustrates a perspective view of a bracket for the hitch attachment;

FIG. 5 illustrates a perspective view of the three point hitch attached with by the attachment points to the rear of a front end loader:

FIG. 6 illustrates a perspective view of the three point hitch swung away on the vertical axis on one side of the attachment points from the rear of a front end loader;

FIG. 7 illustrates a perspective view of a removable top attachment point of the three point hitch on the rear of a front end loader; and

FIG. 8 illustrates a perspective view of a removable top attachment point of the three point hitch on the rear of a front end loader.

### DESCRIPTION OF THE PREFERRED EMBODIMENT

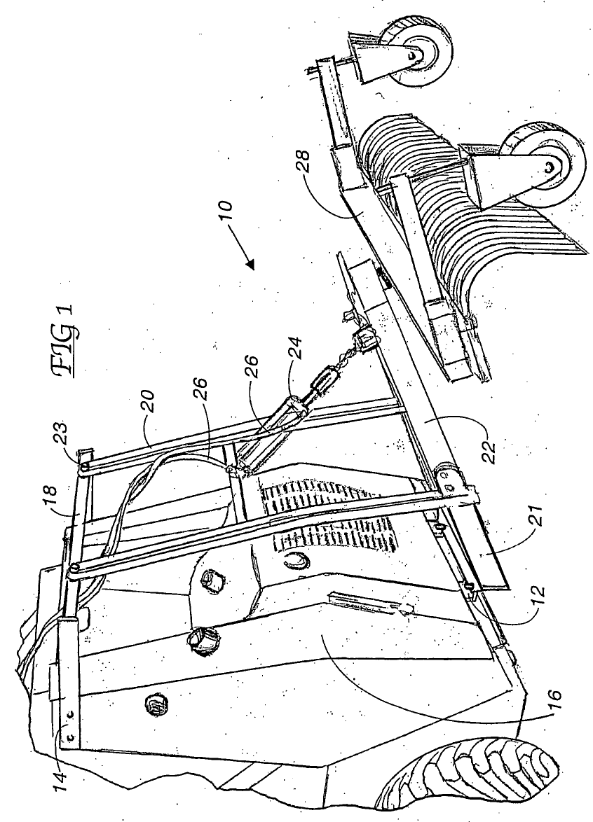

Illustrated in FIG. 1 is new moveable hitch device 10 of the invention. Movable hitch device 10 employs brackets 12 and attachment points 14 and cross bar 18 or other means for holding affixed to the rear of vehicle 16.

Cross bar 18 is affixed across to attachment points 14. Brackets 12 and cross bar 18 can remain attached to vehicle 16. Removable frame 20 connects with pin 23 to top of frame 20 to cross bar 18. Removable frame 20 connects to brackets 12 at bottom of vehicle 16 through lower frame attachment part 21.

Movable intermediate part 22 pivotally connects to the lower part of frame 20. Hydraulic cylinder 24 attaches between frame 20 and movable intermediate part 22. Implement 28 is attached to movable intermediate part 22.

Hydraulic cylinder 24 connects by hydraulic lines 26 to the hydraulic system of the vehicle 16. Hydraulic cylinder 24 is controllable by the vehicle operator to raise and lower movable intermediate part 22 to which implement 28 is attached. Thus, implement 28 can be moved between a position for use and repositioned from the position for use. Implement 28 is shown in raised position in FIG. 1.

Frame 20 is better shown in FIG. 2 with the hydraulic cylinder attached at one end to the frame 20. Lower frame attachment part 21 is shown connected to frame 20.

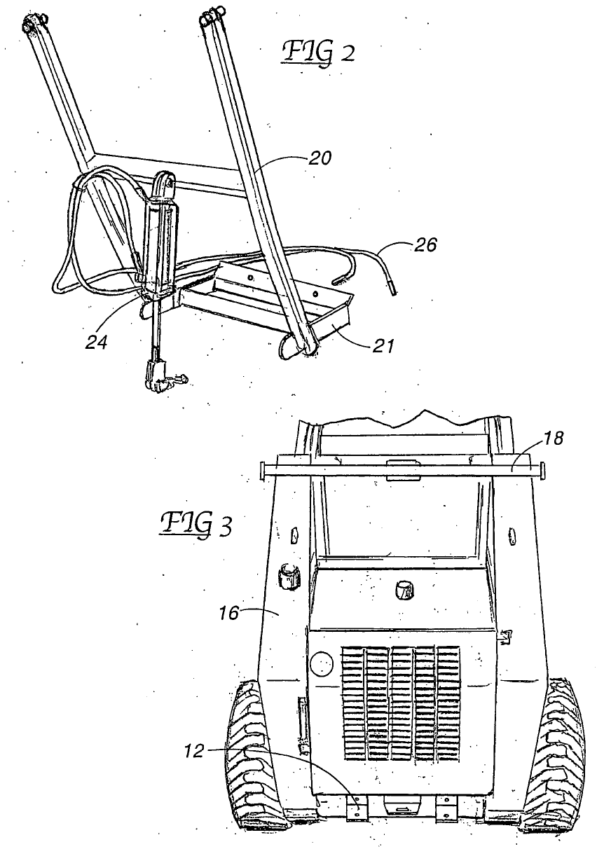

FIG. 3 better depicts cross bar 18 and brackets 12 that remain on vehicle 16.

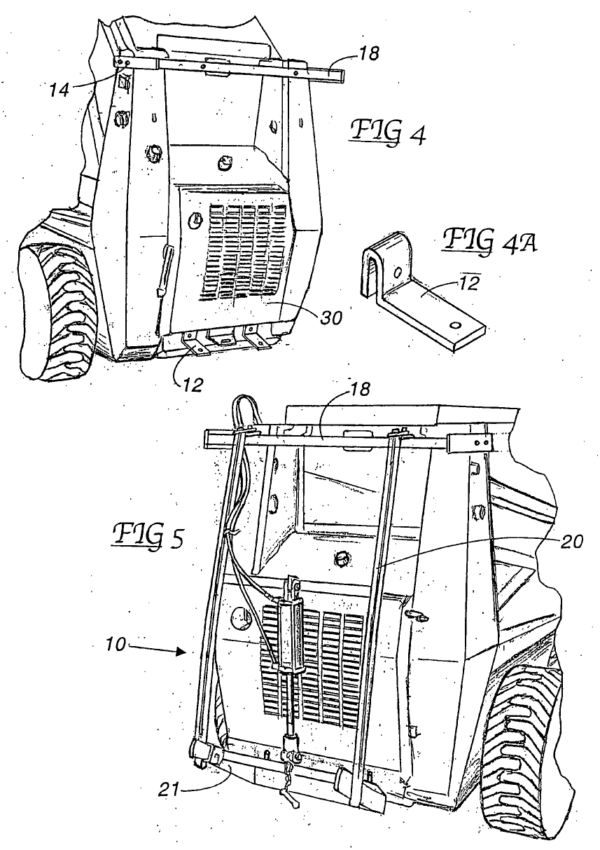

Bracket 12 fits to vehicle 16 and is hereshown as partially covered by radiator cover 30 (FIG. 4). Bracket 12 is better shown in FIG. 4A.

Moveable hitch device 10 is shown in FIG. 5 attached to the vehicle 16 without an implement attached to the moveable hitch device 10.

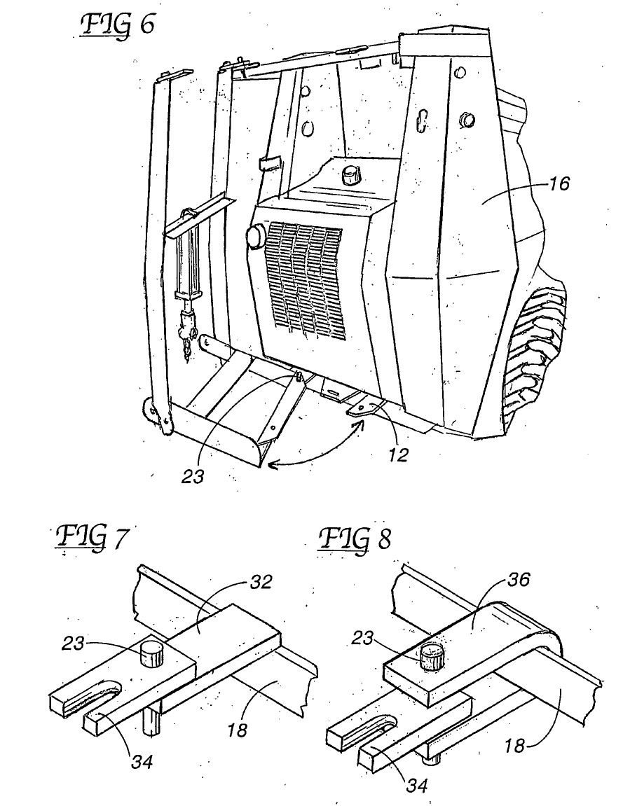

Moveable hitch device 10 can be swiveled around a vertical axis between the attachment points for access to vehicle 16 (FIG. 6). Clip 32 on cross bar 18 is better shown in FIG. 7 as being fixed to cross bar 18. U-shaped arm 34 fits to vertical part of frame 20. Pin 23 connects clip 32 with U-shaped clip 34.

FIG. 8 depicts clip 36 that wraps around cross bar 18. Pin 23 connects clip 36 with U-shaped arm 34.

Removing pin 23 from clip 34 and removing pin 23 at lower edge of hitch from bracket 12 allows hitch 10 to swivel to one side.

1. A movable hitch device for attaching an implement to the rear of a construction vehicle, the hitch comprising:
means for holding affixed to the rear of a vehicle, the means for holding forming attachment points;
a frame connected to the attachment points of the means for holding;
an movable intermediate part connected to the frame; and
means for raising and lowering the movable intermediate part, wherein an implement being attached to the intermediate part can be positioned for use and repositioned from the position for use.

2. The movable hitch device for attaching an implement to the rear of a construction vehicle according to claim 1 further comprising a lower frame attachment part attached between the frame and means for holding.

3. The movable hitch device for attaching an implement to the rear of a construction vehicle according to claim 1 wherein the implement comprises a rake.

4. The movable hitch device for attaching an implement to the rear of a construction vehicle according to claim 1 wherein the hitch comprises a three point hitch

5. The movable hitch device for attaching an implement to the rear of a construction vehicle according to claim 1 wherein the construction vehicle comprises a front end loader.

6. The movable hitch device for attaching an implement to the rear of a construction vehicle according to claim 1 wherein the means for raising and lowering the movable intermediate part comprises a hydraulic cylinder.

7. The movable hitch device for attaching an implement to the rear of a construction vehicle according to claim 1 wherein the attachment points comprise brackets mounted to the vehicle.

8. A removable hitch device for attaching an implement to the rear of a construction vehicle, the hitch device comprising:
means for holding affixed to the rear of a vehicle, the means for holding forming attachment points; and
a frame connected to the attachment points of the means for holding, the frame forming at least one vertical axis between the attachment points, wherein the frame being swivelable about at least one vertical axis.
